(19) United States
(12) Patent Application Publication
(10) Pub. No.: US 2009/0024433 A1
(43) Pub. Date: Jan. 22, 2009

(54) SCHEDULING TASK-RELATED ACTIVITIES IN A COLLABORATION SOFTWARE TOOL

(75) Inventors: Pietro Guardascione, Sydney (AU); Scot MacLellan, Roma (IT)

Correspondence Address: IBM Corp.;(Austin IP Law), c/o Johnson & Associates, P.O. Box 90698, Austin, TX, 78709-0698, US

(73) Assignee: International Business Machines Corporation, Armonk, NY (US)

(21) Appl. No.: 12/174,604

(22) Filed: Jul. 16, 2008

(30) Foreign Application Priority Data
Jul. 17, 2007 (FR) 07112609.8

(51) Int. Cl. G06Q 10/00

(52) U.S. Cl. 705/8

(57) ABSTRACT

Methods, systems, and computer program products for scheduling task-related activities are disclosed. In one example, the values of a one or more of variables on which an activity is dependent are used to determine the attainability of an activity. Information relating to the variables and/or the attainability of the activity can be recorded, or used to generate notifications and/or invitations for users.

### CROSS REFERENCE TO RELATED APPLICATIONS

This application claims priority under 35 U.S.C. § 119 to co-pending, commonly owned French patent application serial number 07112609.8 filed on Jul. 17, 2007, entitled “Method and System for Scheduling Task-Related Activities in a Collaboration Software Tool.”

### BACKGROUND

The disclosure relates to collaborative computing. In particular, the disclosure relates to software tools for scheduling task-related activities in a collaboration software tool.

Collaborative software tools are software tools designed to help users working on a common tasks achieve milestones and common goals. Exemplary collaborative software tools include tools to facilitate email, calendaring, instant messaging or text chat, wiki, etc.

### BRIEF SUMMARY

A method is provided for scheduling a task-related activity in a collaboration software tool including specifying a plurality of variables on which the activity is dependent, determining values of the plurality of variables, wherein values of each of the plurality of variables relate to the attainability of the activity, determining when values of a first set of variables correspond to values of a second set of variables, and recording in the collaboration software tool the values of the first and second sets of variables.

One embodiment provides a computer program product for scheduling a task-related activity in a collaboration software tool, the computer program product including a computer-usable medium having computer usable program code embodied therewith, the computer usable program code including computer usable program code configured to specify a plurality of variables on which the activity is dependent, determine values of the plurality of variables, wherein values of each of the plurality of variables relate to the attainability of the activity, determine when values of a first set of variables correspond to values of a second set of variables, and recording in the collaboration software tool the values of the first and second sets of variables.

One embodiment provides a method of scheduling a task-related activity in a collaboration software tool including determining the availability of a first resource desired for the activity, determining the availability of a second resource desired for the activity, determining a time period that the first and second resources are available, and polling one or more persons to ascertain whether they are available to participate in the activity during the determined time period.

### BRIEF DESCRIPTION OF THE SEVERAL VIEWS OF THE DRAWINGS

The present disclosure is illustrated by way of example and not limitation in the figures of the accompanying drawings, in which like references indicate similar elements and in which:

FIG. 1 is a block diagram of a static dependency resolution implementation of an embodiment for an exemplary activity that depends on the presence of one or more people, the use of a particular room, and a piece of equipment;

FIG. 2 is a block diagram of a real-time dependency resolution implementation of the an embodiment for an exemplary activity that depends on the presence of one or more people at a target date;

FIG. 3 is a block diagram of a hybrid static-real-time dependency resolution implementation of an embodiment for an exemplary activity that depends on the presence of one or more people at a target date, and the use of a meeting place; and

FIG. 4 is a schematic diagram of a computer system.

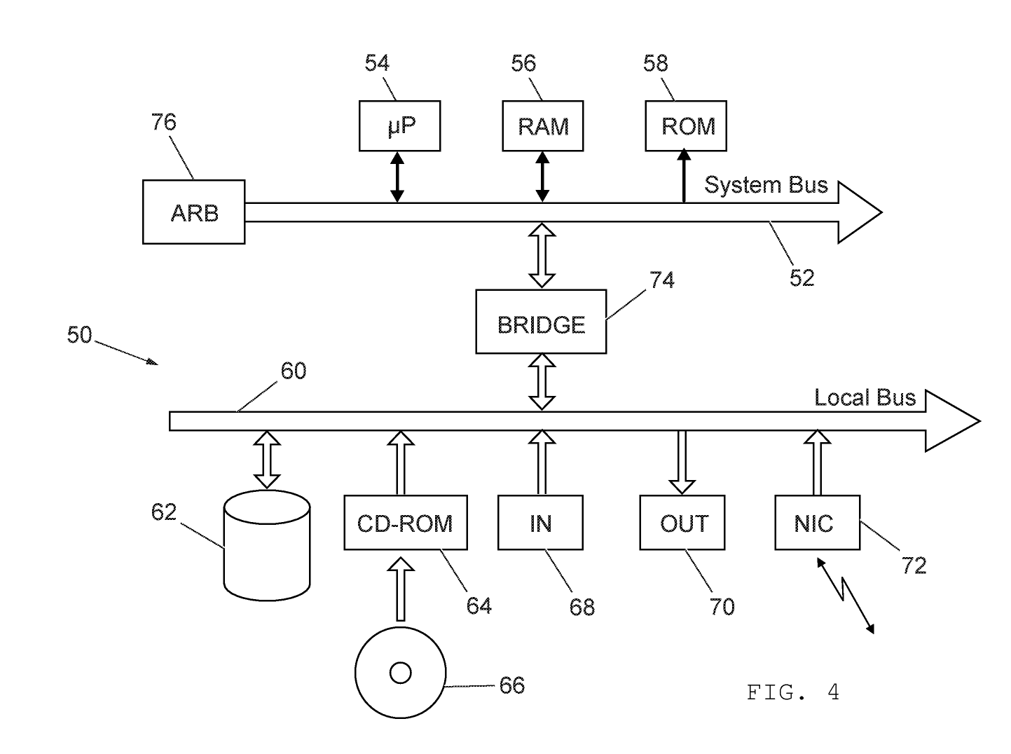

### DETAILED DESCRIPTION

The term “dependency resolution” refers to the establishment of one or more conditions relating to a one or more variables that are satisfied in order for a particular activity to be triggered. An exemplary collaboration tool may provide a facility for associating a task with a deadline or target date entered by a user (i.e. establishing a time dependency for an activity. Such an exemplary tool can checking a system clock to determine whether the target date/time has been reached, and then take appropriate action (e.g., trigger a flag, alarm, notification, etc.) to notify a user that particular activity or event is triggered. In some embodiments of the disclosure, the collaboration tool supports multiple types of dependencies, as described in more detail below. In a multiple dependency embodiment, activities can be dependent on multiple variables. In some embodiments, a collaboration tool can provide also facilities for supporting non-temporal dependencies. For example, an activity can be dependent on the presence of one or more people, the use of a particular (e.g. conference) room or a piece of equipment (e.g. projector or other equipment), etc.

In one exemplary embodiment, a method is provided for scheduling task-related activities in a collaboration software tool including acquiring a plurality of variables on which an activity is dependent, acquiring the values of the plurality of variables, determining the values of a first set of variables (the values being those attainable at a value of a second set of variables), and recording the values of the first and second sets of variables in the collaboration software tool. In one example, a computer program for performing the above-described method is provided. In another example, a system, including way for performing the functions described above, is provided. Some embodiments, are capable of leveraging the interaction with the different components of a collaboration software tool (e.g. chat and calendar systems), to provided capabilities in addition to just single temporal dependency scheduling of events, and thereby facilitate and provide more user functions.

Generally, an embodiment of the disclosure provides an activity support tool which supports one or more generic dependencies that extend beyond simply temporal resolution dependency to encompass variables such as the availability of equipment, availability of rooms or availability of particular persons, etc. Other exemplary variables are also possible. In on example, several functions are integrated together to provide an activity support tool that supports multi-dimensional dependencies.

Described below are three exemplary approaches to implementing an collaborative tool. A first example relates to a static (predictive) dependency resolution. A second example relates to a real-time dependency resolution. A third example relates to a hybrid of the above two approaches. Other examples are also possible.

All of the exemplary implementations listed above allow the specification of several types of dependencies (variables) for a newly created activity. For example, the dependencies could include the availability of n people, the availability of a meeting room (any available place or a particular room, for example), and the availability of other resources such as a projector or other office equipment, etc. The examples listed above enable various options for the manner in which they resolve the multiple dependencies.

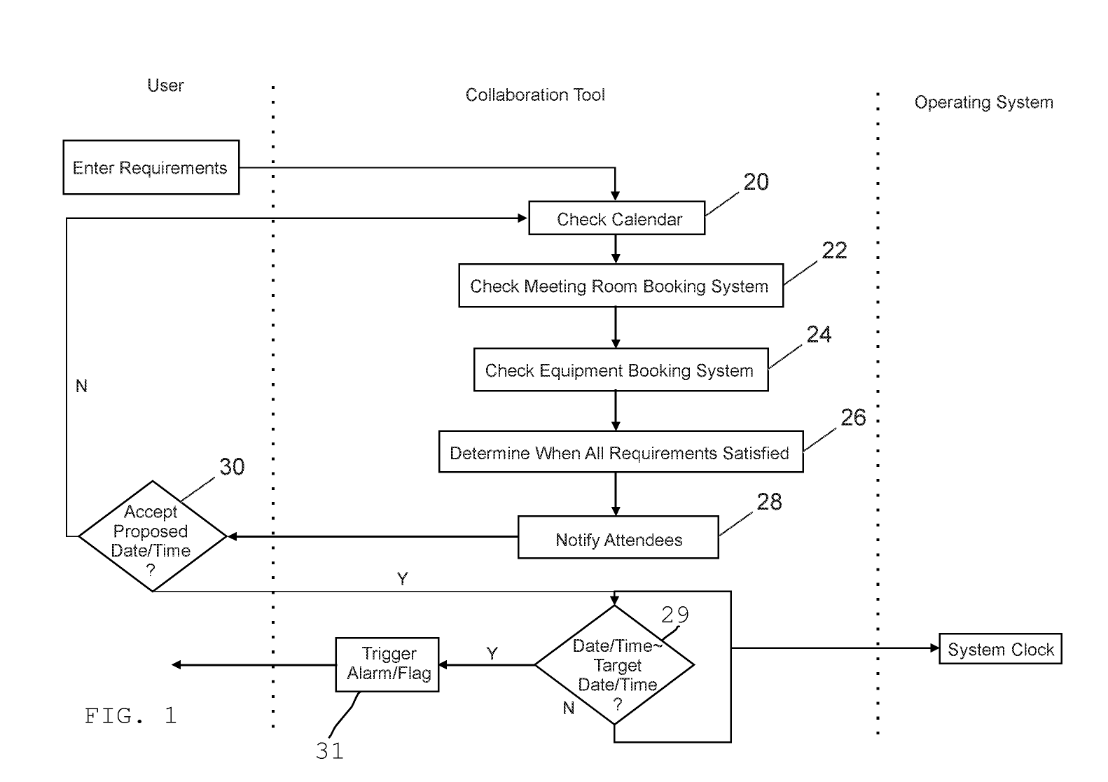

The first example listed above relates to static (predictive) dependency resolution. This example attempts to predict a particular time/date for the dependency resolution by looking at planned availability of the desired variables, and planning for the activity to occur at the most appropriate time/date. Referring to FIG. 1 and using the above example of an activity that specifies the presence of one or more people, the use of a particular (e.g. conference) room and a piece of equipment (e.g. projector), the static example illustrated in FIG. 1 looks into the future using a calendar application (block 20), meeting room booking system (block 22) and equipment booking system (block 24) to determine (block 26) when all of the variables are satisfied (i.e. looking for the first available slot that all of the desired people were free, the meeting room is free and the projector is available). In other words, the collaboration tool determines when the values of multiple variables are all obtainable. For example, assume that all meeting attendees are available on Friday at 2 PM, and a conference room and projector are also available at that time. The collaboration tool can then determine that all three variables are attainable at Friday at 2 PM.

The collaboration tool then notifies (block 28) the desired attendees of the relevant time/date and invites (block 30) the attendees to confirm their acceptance of the relevant time/date. Once the relevant time/date is established and accepted by all the attendees (block 29), the collaboration tool sets an alarm to trigger on the relevant time/date (block 31). In one example, the relevant time/date of the alarm is not changed thereafter. In one embodiment the collaboration tool can book the desired meeting room and reserves the equipment (e.g., projector) for the relevant time/date.

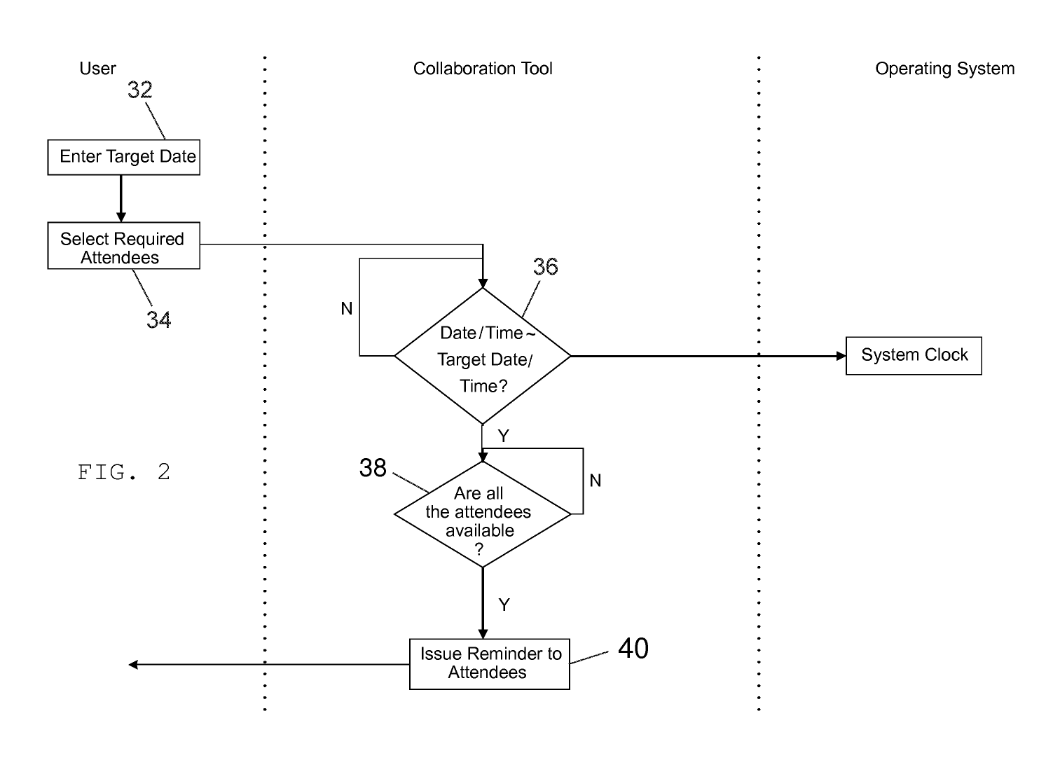

The second example listed above relates to a real-time dependency resolution. In contrast with the static embodiment, the real-time dependency approach does not attempt to predict a future date/time for a specified activity, but instead, resolves the specified dependencies in real-time. Referring to FIG. 2, a target date is set by a first user (block 32), and a group of people that need to be available to perform the activity are chosen (block 34). The target date dependency is checked by comparing (block 36) the specified target date with the time/date of a system clock. Once the system clock reaches the specified target date/time, the collaboration tool checks the availability of the attendees in real-time, by polling (block 38) the attendees through an interface to an instant messaging system (or by using other methods). In one example, the tool can consider those attendees as being available whose instant messaging status is active.

The dependency can also be set to target date minus some predefined interval (e.g. notify me five days before the target date or deadline). When all the conditions of the dependencies are satisfied, then the action (e.g., issue a reminder to the attendees) to trigger the beginning of the activity is executed (block 40). Thus, in essence, the real-time approach effectively monitors, in real time, the availability of specified individuals and triggers an alarm when all the persons are available. Other variables can also be monitored in real-time.

The third example listed above relates to a hybrid dependency resolution. The third example applies the mechanism of the static embodiment to variables such as room availability to predict when the room is next available. The collaboration tool then combines this static information with real-time information regarding the availability of desired attendees to trigger the issuance of invitations to the available attendees to attend the relevant room. In other examples, different variables can be applied to the static and/or real-time approaches, as desired.

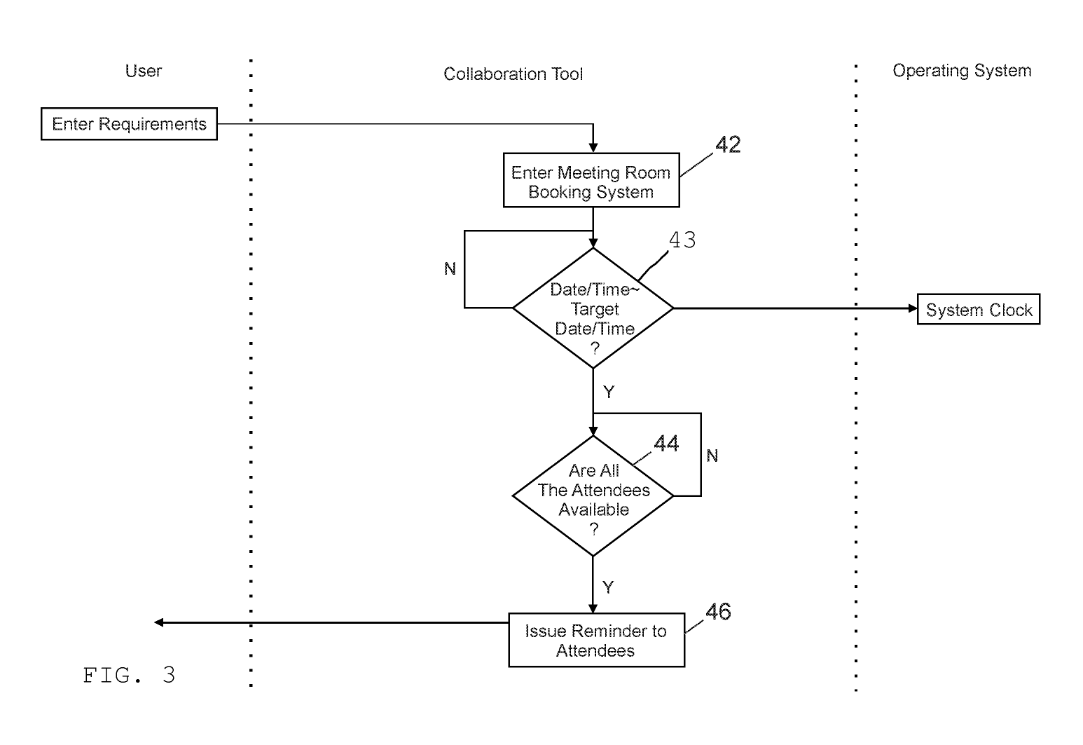

Referring to FIG. 3, and taking the example of a meeting planned in a conference room, an example will be described. In this example a collaboration tool using the hybrid approach looks into a meeting room booking system (block 42) to determine when a suitable meeting place is next available. The predicted time/date then acts as a target time/date for the real time aspect of the collaboration tool. The target date dependency is checked by comparing (block 43) the predicted target date with the time/date of a system clock. Once the system clock reaches the target date/time, the collaboration tool checks the availability of the attendees in real-time, by polling (block 44) around the target time/date to determine which, if any, of them are available. If all desired attendees are available, the collaboration tool will issue (block 46) an invitation/reminder to the available persons to attend the specified meeting room. In another example, an electronic meeting could be booked for a full day, but the intended participants are only sent an invitation to participate in the meeting when all of the participants are active on the relevant network.

From the above description of the various exemplary embodiments, it can be seen that the embodiments are capable of leveraging their interaction with chat and calendar systems (or any other desired system), to facilitate and provide desired user functions.

For instance, the embodiments enable a user to create a proposed activity entry in a “to-do” software tool and specify that the proposed activity corresponds to a meeting of a specified length and is dependent on the availability of a specified set of people. In this case, the tool can automatically check if the dependencies can be resolved (and if they cannot, display a message to that effect) and eventually create an entry for the meeting in a calendar software application (bearing in mind user preferences, such as “search meetings in the morning first,” etc.), send the invitations and book the room.

Similarly, the embodiments enable a user to create a proposed activity entry in a “to-do” software tool and specify that the proposed activity depends on the availability a specified set of people for a chat. The tool could then start waiting for all desired people to be available to chat and pop-up an alarm as soon as an appropriate subset of the desired participants becomes available (again some preferences such as “alert me when 80% of the desired people are available” could be set, as desired).

Furthermore, the collaboration tool can leverage a calendar, chat and room booking system, or any other resource management system, for example, in many other combinations (e.g. display a message as soon as all conditions are reached, and sound alarm only when deadline is near, or display a message when user is available, but sound alarm only when all conditions are reached etc.)

Referring to FIG. 5, an exemplary computer system 50 adapted to support the described embodiments is formed by several units that are coupled in parallel to a system bus 52. In this example, one or more microprocessors (μP) 54 control operation of the computer system 50, A RAM 56 is directly used as a working memory by the microprocessors 54, and a ROM 58 stores basic code for a bootstrap of the computer 50. Peripheral units are clustered around a local bus 60, by means of respective interfaces. Particularly, a mass memory consists of a hard-disk(s) 62 and a drive 64 for reading CD-ROMs 66 or other media. The computer system 50 includes input devices 68 (for example, a keyboard and a mouse), and output devices 70 (for example, a monitor and a printer). A Network Interface Card (NIC) 72 is used to connect the computer 50 to the network. A bridge unit 74 interfaces the system bus 52 with the local bus 60. The microprocessor 54 and bridge unit 74 can operate as master agents requesting access to the system bus 52 for transmitting information. An arbiter 76 manages the granting of the access with mutual exclusion to the system bus 52.

Similar considerations apply if the system has a different topology, or it is based on other networks. Alternatively, the computers have a different structure, include equivalent units, or consist of other data processing entities (such as PDAs, mobile phones, and the like).

Embodiments may take the form of an entirely hardware embodiment, an entirely software embodiment or an embodiment containing both hardware and software elements. An embodiment that is implemented in software may include, but is not limited to, firmware, resident software, microcode, etc.

Furthermore, embodiments may take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system, (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code in order to reduce the number of times code is retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A method of scheduling a task-related activity in a collaboration software tool comprising:
specifying a plurality of variables on which the activity is dependent;
determining values of the plurality of variables, wherein values of each of the plurality of variables relate to the attainability of the activity;
determining when values of a first set of variables correspond to values of a second set of variables; and
recording in the collaboration software tool the values of the first and second sets of variables.

2. The method of claim 1, wherein determining when values of a first set of variables correspond to values of a second set of variables further comprises determining a time period when the values of the first and second set of variables correspond to the attainability of the activity.

3. The method of claim 2, further comprising polling one or more specified persons to ascertain whether they are available to participate in the activity during the time period when the values of the first and second set of variables correspond to the attainability of the activity.

4. The method of claim 3, further comprising determining whether a desired number of the specified persons are available to participate in the activity during the time period when the values of the first and second set of variables correspond to the attainability of the activity.

5. The method of claim 4, further comprising issuing one or more invitations to the specified persons that have been determined to be available to participate in the activity.

6. The method of claim 1, wherein the first and second sets of variables relate to the availability of resources desired for the activity.

7. The method of claim 6, wherein one of the variables relate to the availability of a meeting place.

8. The method of claim 6, wherein one of the variables relate to the availability of equipment desired for the activity.

9. The method of claim 1, wherein determining when values of a first set of variables correspond to values of a second set of variables further comprises, during a specified time period, polling one or more persons to ascertain whether they are available to participate in the activity.

10. The method of claim 1, wherein determining when values of a first set of variables correspond to values of a second set of variables further comprises:
determining when a first resource is available; and
when the first resource is available, polling one or more persons to ascertain whether they are available to participate in the activity.

11. A computer program product for scheduling a task-related activity in a collaboration software tool, the computer program product comprising:
a computer-usable medium having computer usable program code embodied therewith, the computer usable program code comprising:
computer usable program code configured to specify a plurality of variables on which the activity is dependent, determine values of the plurality of variables, wherein values of each of the plurality of variables relate to the attainability of the activity, determine when values of a first set of variables correspond to values of a second set of variables, and recording in the collaboration software tool the values of the first and second sets of variables.

12. A method of scheduling a task-related activity in a collaboration software tool comprising:
determining the availability of a first resource desired for the activity;
determining the availability of a second resource desired for the activity;
determining a time period that the first and second resources are available; and
polling one or more persons to ascertain whether they are available to participate in the activity during the determined time period.

13. The method of claim 12, further comprising scheduling the activity for the determined time period if a desired number of persons are available during the time period.

14. The method of claim 12, wherein the one or more persons are polled at a time close to or during the determined time period.

15. The method of claim 12, wherein the first resource relates to a meeting place for the activity.

16. The method of claim 15, wherein the availability of the first resource is determined using a meeting room booking system.

17. The method of claim 15, wherein the second resource relates to desired equipment for the activity.

18. The method of claim 17, wherein the availability of the second resource is determined using a equipment booking system.
